(19) United States
(12) Patent Application Publication
(10) Pub. No.: US 2006/0048168 A1
(43) Pub. Date: Mar. 2, 2006

(54) Tray and disc driving apparatus having the same

(75) Inventors: Bin-Hai Guo, Shenzhen (CN); Chien-Ting Lo, Tu-Cheng (TW); Li-Ming Wan, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/216,517

(22) Filed: Aug. 31, 2005

(30) Foreign Application Priority Data
Sep. 1, 2004 (CN) 200420083705.6

(51) Int. Cl. G11B 17/04; G11B 17/03; G11B 33/02

(52) U.S. Cl. 720/603

(57) ABSTRACT

A tray for a disc driving apparatus comprises a main body and at least one receiving portion. The receiving portion is formed in the main body for receiving a disc, and includes a gently sloped bottom.

### BACKGROUND OF THE INVENTION

1. Field of the Invention

The present invention relates to trays for use in disc driving apparatuses such as those in optical disc drives, and more particularly to a tray for a disc driving apparatus having an improved loading structure whereby a disc mounted thereon avoids being scraped or damaged.

2. Description of Related Art

Optical discs such as CDs (compact discs), DVDs (digital versatile discs) or LDs (laser discs) are in widespread use as storage mediums nowadays. In general, these discs may be classified into two classes: discs having a diameter of 12 cm, and discs having a diameter of 8 cm. A typical optical disc generally includes a substrate, a recorded layer, and an adhesive layer. The substrate is generally formed of a transparent material, which allows light rays to pass therethrough. The recorded layer is employed to record information by means of a plurality of pits formed therein.

Disc driving apparatuses include two kinds: a tray-loading type and a slot-in type. As regards a tray-loading type driving apparatus, in order to record/reproduce information onto/from an optical disc, the disc is first placed on a tray and is loaded into a main unit of the driving apparatus via the tray. Once loaded, the disc is mounted on a turntable and is rotated by a spindle motor. Light rays emitted from an optical pickup are then converged onto the disc for recording/reproducing information.

FIGS. 5 and 6 represent a conventional optical disc 9 and a tray 8 for accommodating the disc 9. The disc 9, from a center to a periphery thereof, includes a center hole 90, a mounting portion 92, a data-recoding portion 94, and a rim non-recording portion 96. The center hole 90, the mounting portion 92 and the rim non-recording portion 96 are for facilitating a user to hold the disc 9 with his/her fingers. The mounting portion 92 is also for mounting of the disc 9 on the turntable of the spindle motor. The data-recording portion 94 is for storing information.

The tray 8 is generally rectangular, and includes a first concavity 82 for receiving a disc having a diameter of 12 cm and a second concavity 84 for receiving a disc having a diameter of 8 cm. First and second bottoms 820, 840 of the tray 8 in the corresponding first and second concavities 82, 84 are both flat, as illustrated in FIG. 7. When the disc 9, either the 12 cm disc or the 8 cm disc, is placed in the first concavity 82 or the second concavity 84, the data-recording portion 94 and the mounting portion 96 of the disc 9 come into contact with the first or second bottoms 820, 840. However, rough or uneven surfaces of the first and second bottoms 820, 840 may cause the substrate of the disc 9 to be scraped or even damaged. Further, tiny granules of dust on the first and second bottoms 820, 840 may also cause scraping and damage. As a result, it may be difficult for the light rays emitted from the pickup to track the correct track of the disc.

In view of this problem, an improved tray has been developed. Protrusions are formed along an outer circumference of the recess in the tray. A height of each of the protrusions is less than a thickness of the disc. The bottoms of the tray in the recess are flat. When the disc is placed in the recess, the rim non-recording portion of the disc is supported by the protrusions so as to avoid direct contact between the data-recording portion of the disc and the tray at the bottom of the recess. However, in fact, potential risks of scraping or even damage to the data-recording portion may still remain. For example, when the user places the disc onto the tray, the user may press and rotate the disc, whereby the disc is deformed downwardly. When this happens, the data-recording portion is brought come into contact with the tray at the bottom of the recess, because the distance between the tray bottom and the underside of the disc is generally not large.

Accordingly, what is needed is a tray for a disc driving apparatus, whereby a disc mounted on the tray can avoid being scraped or damaged. What is also needed is a disc driving apparatus employing such tray.

### SUMMARY

A tray for a disc driving apparatus comprises a main body and at least one receiving portion. The receiving portion is formed in the main body for receiving a disc, and includes a gently sloped bottom.

A disc driving apparatus comprises a case provided with a turntable and a pickup therein, and a tray as described above.

### BRIEF DESCRIPTION OF THE DRAWINGS

The above-mentioned and other features and advantages will become more apparent and the invention will be better understood by reference to the following description of embodiments of the invention taken in conjunction with the accompanying drawings, wherein:

FIG. 1 is an isometric view of a disc driving apparatus with a tray, in accordance with a first embodiment of the present invention;

FIG. 2 is an isometric view of the tray of FIG. 1, with a disc placed thereon;

FIG. 3 is a cross-sectional view taken along line III-III of FIG. 2;

FIG. 4 is an isometric view of a tray in accordance with a second embodiment of the present invention;

FIG. 5 is an isometric view of a conventional disc, ready to be placed on a conventional tray;

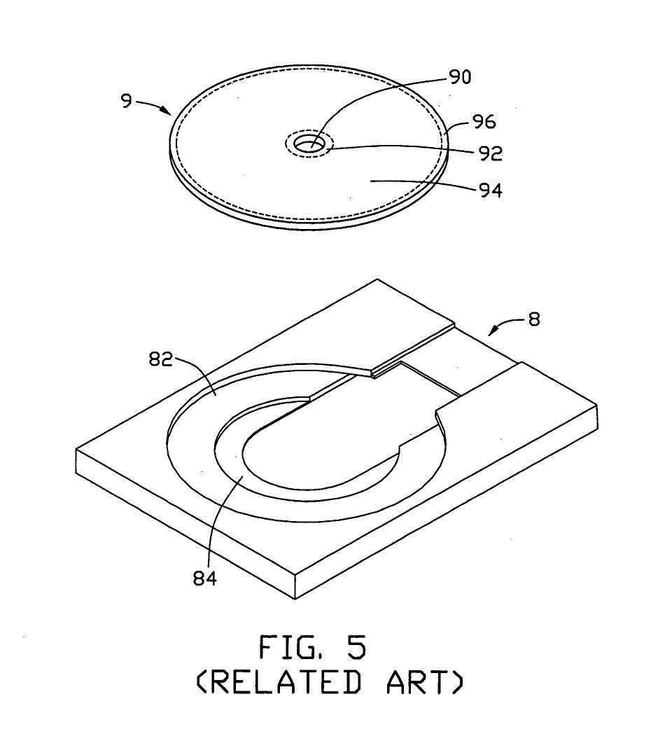

FIG. 6 is similar to FIG. 5, but showing the disc placed on the tray; and

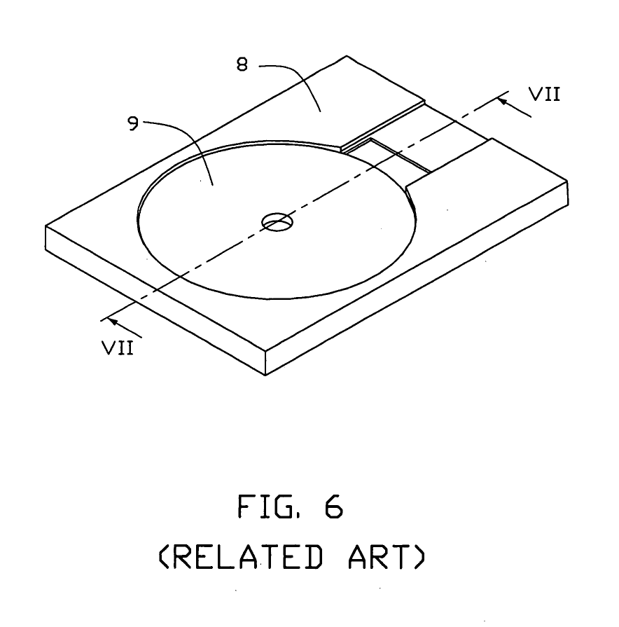

FIG. 7 is a cross-sectional view taken along line VII-VII of FIG. 6.

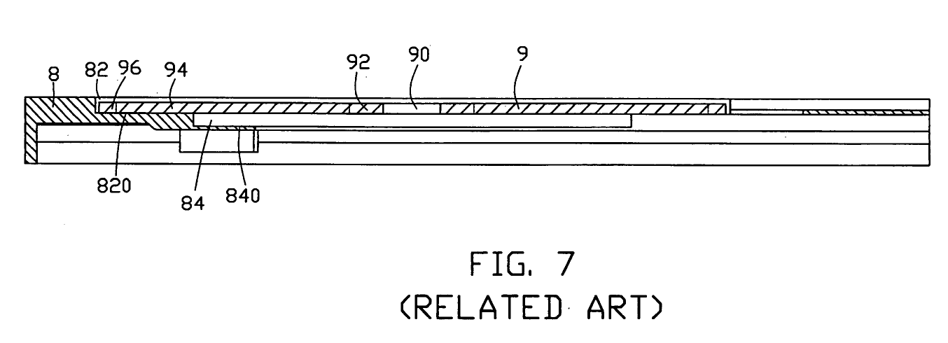

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF PREFERRED EMBODIMENTS

Reference will now be made to the drawing figures to describe the embodiments of the present invention in detail.

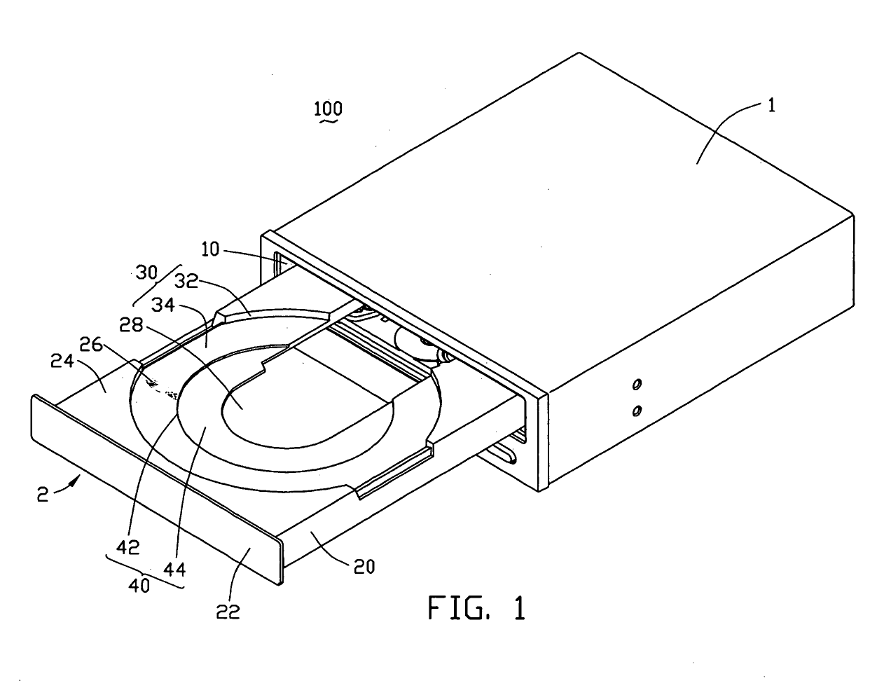

Referring to FIG. 1, a disc driving apparatus 100 according to a first embodiment of the present invention is illustrated. The disc driving apparatus 100 includes a case 1 and a tray 2. The case 1 includes an entrance 10 in a front thereof for allowing extension or retraction of the tray 2 therethrough.

The tray 2 includes a main body 20 and a panel 22. The panel 22 is detachably attached to a front end of the main body 20. The main body 20 includes an upper surface 24, a recess 26, and an opening 28. The recess 26 is defined at the upper surface 24 for accommodating optical discs therein. The opening 28 is defined in the main body 20 for allowing a turntable (not shown) mounted on a spindle motor (not shown) and light rays emitted from a pickup device (not shown) installed in the case 1 to pass therethrough.

In more detail, the recess 26 includes a first concavity 30 as a first receiving portion for receiving a disc having a diameter of 12 cm (hereinafter, referred to as “12 cm disc”) and a second concavity 40 as a second receiving portion for receiving a disc having a diameter of 8 cm (hereinafter, referred to as “8 cm disc”). The first and second concavities 30, 40 are concentric with each other. A stepped structure is formed where the first and second concavities 30, 40 adjoin each other. The main body 20 comprises a first sidewall 32, and a first bottom 34 in the first concavity 30. A disc-load plane is defined when the 12 cm disc is loaded in the fist concavity 30. The first bottom 34 gently slopes down from a periphery thereof toward a center of the first concavity 30, i.e., slopes away from the defined disc-load plane starting from a periphery thereof toward a center of the first concavity 30. A radial angle of the slope of the first bottom 34 is preferably approximately 1 degree. The angle of the slope and is not generally greater than 3 degrees. A diameter of the first bottom 34 is slightly greater than an outer diameter of the 12 cm disc, for facilitating the loading and removing of the 12 cm disc by a user. A surface of the first bottom 34 is roughened, so that the surface has a large static friction coefficient sufficient to maintain the 12 cm disc at rest relative to the tray 2 during ejection or insertion of the tray 2.

The second concavity 40 is surrounded by the first concavity 30. The main body 20 of the tray 2 has a second sidewall 42, and a second bottom 44 in the second concavity 40. The second bottom 44 gently slopes down from a periphery thereof toward a center of the second concavity 40. A radial angle of the slope of the second bottom 44 is preferably approximately 5 degrees. The angle of the slope is generally not greater than 10 degrees. A diameter of the second bottom 44 is slightly greater than an outer diameter of the 8 cm disc, for facilitating the loading and removing of the 8 cm disc by the user. A surface of the second bottom 44 is roughened, so that the surface has a large static friction coefficient sufficient to maintain the 8 cm disc at rest relative to the tray 2 during the ejection or insertion of the tray 2.

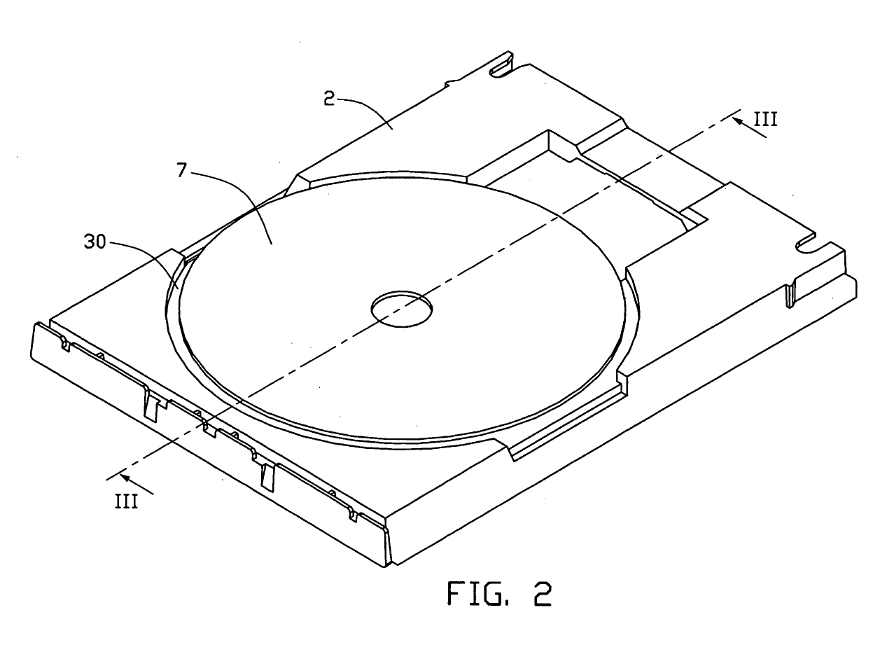

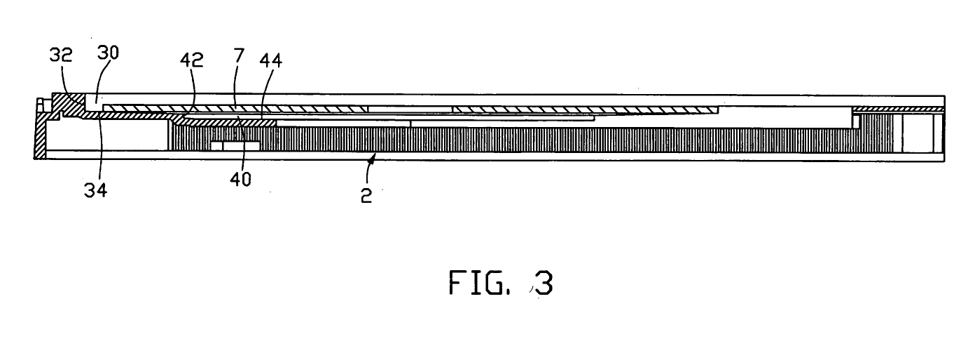

Referring also to FIGS. 2 and 3, when the 12 cm disc 7 is placed into the first concavity 30, only a peripheral part of the rim non-recording portion of the disc 7 is supported on the first bottom 34, while the other portions of the disc 7 are not in contact with the first bottom 34 due to the sloping of the first bottom 34. The first concavity 30 provides enough space for allowing free downward deformation of the disc 7 when the disc 7 is depressed by the fingers of the user. Only the rim non-recording portion of the disc 7 contacts the first bottom 34. Therefore, any scraping or damage to the data-recording portion of the disc 7 is avoided.

When utilizing the second concavity 40 of the tray 2 to accommodate an 8 cm disc 7, the situation and advantages are similar to those described above in relation to the first concavity 30 accommodate the 12 cm disc 7.

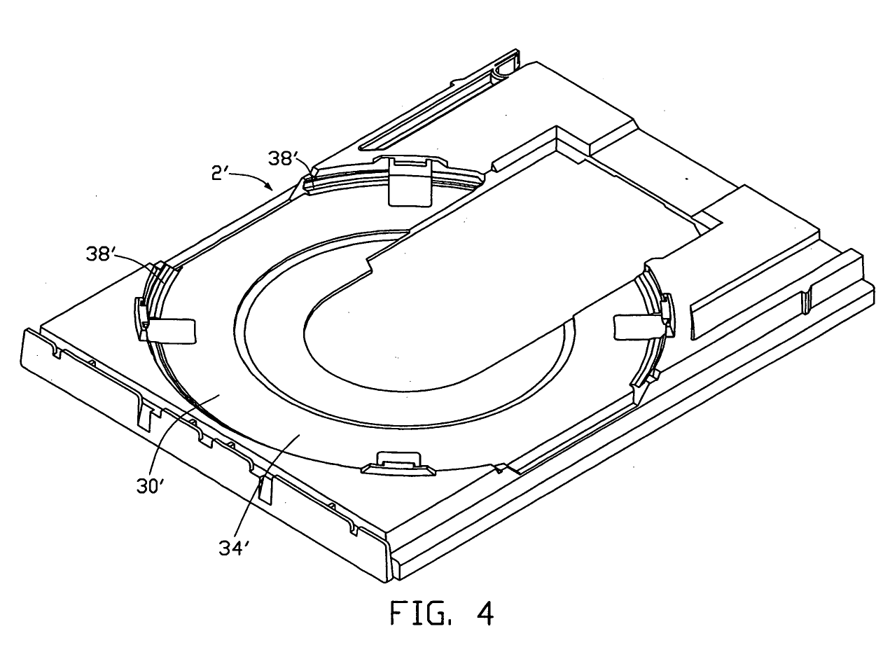

Referring to FIG. 4, a tray 2′ according to a second embodiment of the present invention is illustrated. Most of the structure of the tray 2′ is similar to that of the tray 2 of the first embodiment. However, a plurality of protrusions 38′ is formed along circumferential portions of the first concavity 30′ of the tray 2′. A height of each of the protrusions 38′ is less than a thickness of the 12 cm disc. The bottom 34′ of a main body of the tray 2′ in the first concave 30′ is similar to that of the first embodiment. When the 12 cm disc is placed in the first concavity 30′, the rim non-recording portion of the 12 cm disc is supported on the protrusions 38′ so that contact between the data-recording portion of the 12 cm disc and the first bottom 34′ is avoided. Any scraping or damage to the data-recording portion is avoided, even if the user depresses the 12 cm disc. This is because a distance between an underside of the 12 cm disc and the first bottom 34′ is large enough to allow free downward deformation of the 12 cm disc.

Although the present invention has been described with reference to specific embodiments, it should be noted that the described embodiments are not necessarily exclusive, and that various changes and modifications may be made to the embodiments without departing from the scope of the invention as defined by the appended claims.

We claim:

1. A tray for a disc driving apparatus, comprising:
a main body;
a first receiving portion formed in the main body for receiving a disc, the first receiving portion including a first bottom, wherein the first bottom slopes down from a periphery of the first receiving portion toward a center of the first receiving portion.

2. The tray as described in claim 1, wherein a radial angle of the slope of the first bottom is not greater than 3 degrees.

3. The tray as described in claim 2, wherein the angle of the slope of the first bottom is approximately 1 degree.

4. The tray as described in claim 1, wherein the first bottom has a rough surface.

5. The tray as described in claim 1, further comprising a plurality of protrusions formed along circumferential portions of the first receiving portion.

6. The tray as described in claim 5, wherein a height of each of the protrusions is less than a thickness of the disc.

7. The tray as described in claim 1, further comprising a second receiving portion formed in the first receiving portion, wherein the second receiving portion has a second bottom, wherein the second bottom slopes down from a periphery of the second receiving portion toward a center of the second receiving portion.

8. The tray as described in claim 7, wherein a radial angle of the slope of the second bottom is not greater than 10 degrees.

9. The tray as described in claim 8, wherein the angle of the slope of the second bottom is approximately 5 degrees.

10. A disc driving apparatus, comprising:
a case comprising a turntable and a pickup received therein; and
a tray comprising a main body and a first receiving portion defining a disc-load plane thereon, wherein the first receiving portion is formed in the main body for receiving a disc along the defined disc-load plane, the first receiving portion includes a first bottom, and the first bottom slopes away from the disc-load plane starting from a periphery of the first receiving portion toward a center of the first receiving portion.

11. The disc driving apparatus as described in claim 10, wherein a radial angle of the slope of the first bottom away from the disc-load plane is not greater than 3 degrees.

12. The disc driving apparatus as described in claim 11, wherein the radial angle of the slope of the first bottom away from the disc-load plane is approximately 1 degree.

13. The disc driving apparatus as described in claim 10, wherein the first bottom has a rough surface.

14. The disc driving apparatus as described in claim 10, further comprising a plurality of protrusions formed along circumferential portions of the first receiving portion.

15. The disc driving apparatus as described in claim 14, wherein a height of each of the protrusions is less than the thickness of the disc.

16. The disc driving apparatus as described in claim 10, further comprising a second receiving portion formed in the first receiving portion, wherein the second receiving portion has a second bottom, and the second bottom slopes away from the disc-load plane starting from a periphery of the second receiving portion toward a center of the second receiving portion.

17. The disc driving apparatus as described in claim 10, wherein a radial angle of the slope of the second bottom away from the disc-load plane is not greater than 10 degrees.

18. The disc driving apparatus as described in claim 10, wherein the radial angle of the slope of the second bottom away from the disc-load plane is approximately 5 degrees.

19. A disc driving apparatus, comprising:
means for performing functions of said disc driving apparatus;
a case enclosing said disc driving apparatus and said means therein; and
a tray comprising a main body and a receiving portion having a bottom and defining a disc-load plane therein when a disc is loaded in said receiving portion beside said bottom, a distance between said disc-load plane and an area of said bottom closer to a periphery of said bottom of said receiving portion being smaller than a distance between said disc-load plane and another area of said bottom closer to a center of said bottom of said receiving portion.

20. The disc driving apparatus as described in claim 19, wherein said bottom is a rough surface having a large static friction coefficient to contact with said disc to be loaded in said receiving portion.
